(19) United States
(12) Patent Application Publication
(10) Pub. No.: US 2004/0223659 A1
(43) Pub. Date: Nov. 11, 2004

(54) Filter circuit

(75) Inventor: Tetsuo Minai, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 10/832,429

(22) Filed: Apr. 27, 2004

(30) Foreign Application Priority Data
May 8, 2003 (JP) 2003-129732

(51) Int. Cl. G06K 9/40

(52) U.S. Cl. 382/262

(57) ABSTRACT

Disclosed herein is a filter circuit receiving the values of a pixel to be observed and of each pixel within a window containing the pixel to be observed as input data expressed by integers, for replacing the value of the pixel to be observed with the value of pixel at a predetermined ordinal position in an ascending or descending order within the window, including: an extreme value retaining means for obtaining and retaining an extreme value of the values of the pixels within the window; and a data retrieval determination means receiving extreme value data from the extreme value retaining means and the input data, for obtaining the value at a predetermined ordinal position in the ascending or descending order by cumulatively adding frequencies of occurrence of the values of the pixels within the window.

This application claims benefit of Japanese Patent Application No. 2003-129732 filed in Japan on May 8, 2003, the contents of which are incorporated by this reference.

### BACKGROUND OF THE INVENTION

The present invention relates to filter circuits to be used as a means for removing noise components in the value of each pixel of multi-valued digital image.

Generally, median filters are known as the means for removing the noise components in each pixel value of multi-valued digital image. A median filter is the filter having the following function. In particular, a pixel to be observed and a matrix-like window M×N (M, N being a natural number) as the window containing the pixel to be observed are set in the first place. With the function of the filter, then, the values of the pixels within the window are acquired and the values of the pixels are reordered into an ascending or descending order so as to obtain a median thereof to substitute the median for the value of the pixel to be observed.

When such a median filter is to be achieved by means of digital circuits, a comparator for comparing the levels of the values is generally used in order to reorder the values of the pixels according to the ascending or descending order. A circuit for obtaining the median by using a comparator has been disclosed in Japanese Patent Application Laid-Open Hei-7-336192.

FIG. 1 is a block diagram showing a median circuit as disclosed in the above mentioned publication. The median circuit 100 includes: maximum value circuits 101, 102, 103 for selecting and outputting a maximum value of two signals; and minimum value circuits 104, 105 for selecting and outputting a minimum value of two signals. Note that numerals 106, 107 in FIG. 1 each denote a delay circuit for gradually delaying input signals.

FIG. 2 is a block diagram showing a maximum/minimum value circuit as described above. The maximum/minimum value circuit includes: a comparator circuit 111 for comparing the digital values of two input signals (a), (b) with each other; and a selection circuit 113 for selecting and outputting one or the other of the two input signals (a), (b) based on a comparison result 112 at the comparator 111.

The maximum value circuits 101, 102, 103 are to output respective maximum values of the combinations of two signals (a-b, b-c, c-a) that are obtained from three input signals a, b, c. The minimum value circuit 104 selects and outputs a minimum of the respective output signals of the maximum value circuits 101 and 102. The minimum value circuit 105 selects and outputs a minimum of the output signal of the minimum value circuit 104 and the output signal of the maximum value circuit 103.

Supposing for example the relative values of the three input signals a, b, c are represented by a≧b≧c, a is outputted from the maximum value circuit 101, b from the maximum value circuit 102, and a from the maximum value circuit 103. Next the minimum value circuit 104 outputs b as the minimum value of a and b, and the minimum value circuit 105 outputs b as the minimum value of b and a. The median b of the input signals a, b, c is thereby outputted.

In this manner, according to the technique disclosed in the above mentioned publication, a median filter formed of digital circuits for obtaining the median can be constructed by using a comparator circuit.

Further, a technique for constructing a filter circuit for acquiring the median without using a comparator has been disclosed in Japanese Patent Application Laid-Open No. 2000-293681. FIG. 3 is a-block diagram showing a filter circuit for obtaining the median without using a comparator as disclosed in the above mentioned publication. This median filter circuit includes: a histogram updating circuit 201; a histogram memory 202; and a median selecting adder 203. The histogram updating circuit 201 includes: a decoder 211; histogram memories 212A to 212F; an adder 213; and a subtractor 214.

In thus constructed histogram updating circuit 201, the subject window of the median filter processing is relocated so that histogram data of the value of pixel newly added to the window is obtained and stored to the local histogram memory 212A. By sequentially shifting the values of the local histogram memories 212B to 212F corresponding to each column of the window, the value of the pixel to be excluded from the window is stored into the local histogram memory 212F.

The data of the histogram memory 202 is updated by adding and subtracting the histogram data stored in the local histogram memory 212A and histogram data stored in the local histogram memory 212F. The histogram data are then cumulatively added in order of their magnitudes by the median selecting adder 203. The histogram data where the cumulatively added data becomes that of the ordinal position at the middle of the window size is the median in the window.

In this manner, it is possible according to the technique disclosed in the above mentioned publication to construct a median filter circuit for acquiring the median without using a comparator.

### SUMMARY OF THE INVENTION

It is an object of the present invention to provide a filter circuit capable of high-speed processing, which can be constructed by small-scale digital circuits based on simplification of the processing.

In a first aspect of the invention, there is provided a filter circuit receiving the values of a pixel to be observed and of each pixel within a window containing the pixel to be observed as input data expressed by integers, for replacing the value of the pixel to be observed with the value of pixel at a predetermined ordinal position in an ascending or descending order within the window, including: an extreme value retaining means for obtaining and retaining an extreme value of the values of the pixels within the window; and a data retrieval determination means receiving extreme value data from the extreme value retaining means and the input data, for obtaining the value at a predetermined ordinal position in the ascending or descending order by cumulatively adding frequencies of occurrence of the values of the pixels within the window.

In a second aspect of the invention, the data retrieval determination means in the filter circuit according to the first aspect includes: a data retrievable memory capable of storing the values of each pixel located within the window and capable of outputting information of the number of addresses having coincident values by effecting data retrieval; a retrieval data forming means for inputting retrieval data to the data retrievable memory; and a counter means for cumulatively adding the information of the number of addresses having values coinciding the retrieval data.

In a third aspect of the invention, the data retrievable memory in the filter circuit according to the second aspect arranges the values of each pixel within the window into groups each of pixels of a same row or column and stores data thereof with assigning an address to each group so that, in obtaining the value of pixel at the predetermined ordinal position in the ascending or descending order corresponding to one frame by relocating the pixel to be observed and the window containing the pixel to be observed in a predetermined direction, only the data of the group of the pixels of the same row or column excluded from the window are updated using data newly added to the window.

In a fourth aspect of the invention, the filter circuit according to the second or third aspect uses a contents-addressable memory as the data retrievable memory.

In a fifth aspect of the invention, the retrieval data forming means in the filter circuit according to any one of the second to fourth aspects forms the retrieval data by using the extreme value retained at the extreme value retaining means as an initial value.

In a sixth aspect of the invention, the counter means in the filter circuit according to any one of the second to fifth aspects outputs a carry at a count of or more than the predetermined ordinal position in the ascending or descending order and uses the carry as a heuristic signal of the value of pixel at the predetermined ordinal position in the ascending or descending order.

In a seventh aspect of the invention, the extreme value retaining means in the filter circuit according to the first aspect arranges the values of each pixel within the window into groups each of pixels of a same row or column and obtains and retains an extreme value separately for each group so that, in obtaining the value of pixel at the predetermined ordinal position in the ascending or descending order corresponding to one frame by relocating the pixel to be observed and the window containing the pixel to be observed in a predetermined direction, only the extreme value of the group of the pixels of the same row or column excluded from the window are updated using an extreme value of data of the group newly added to the window.

In an eighth aspect of the invention, the data retrieval determination means in the filter circuit according to the sixth aspect outputs the retrieval data at the time of the outputting of the heuristic signal from the counter means as the value of pixel at the predetermined ordinal position in the ascending or descending order.

### BRIEF DESCRIPTION OF THE DRAWINGS

FIG. 1 is a block diagram showing a prior-art median circuit.

FIG. 2 is a block diagram showing a maximum value circuit and minimum value circuit in the median circuit shown in FIG. 1.

FIG. 3 is a block diagram showing another example of the prior-art median filter circuit.

FIG. 4 is a block diagram showing an embodiment of the filter circuit according to the present invention.

FIG. 5 is a block diagram showing an example of detailed circuit construction of a retrieval data forming circuit in the embodiment shown in FIG. 4.

FIG. 6 is a block diagram showing an example of detailed circuit construction of an extreme value retaining circuit in the embodiment shown in FIG. 4.

FIG. 7 is a block diagram showing an example of detailed circuit construction of a same row/column extreme value retaining circuit in the extreme value retaining circuit shown in FIG. 6.

FIG. 8 illustrates the setting of a processing window, same row pixel groups, and a pixel to be observed with respect to a pixel matrix.

FIG. 9 is a flowchart showing the filtering processing operation in the filter circuit according to the embodiment.

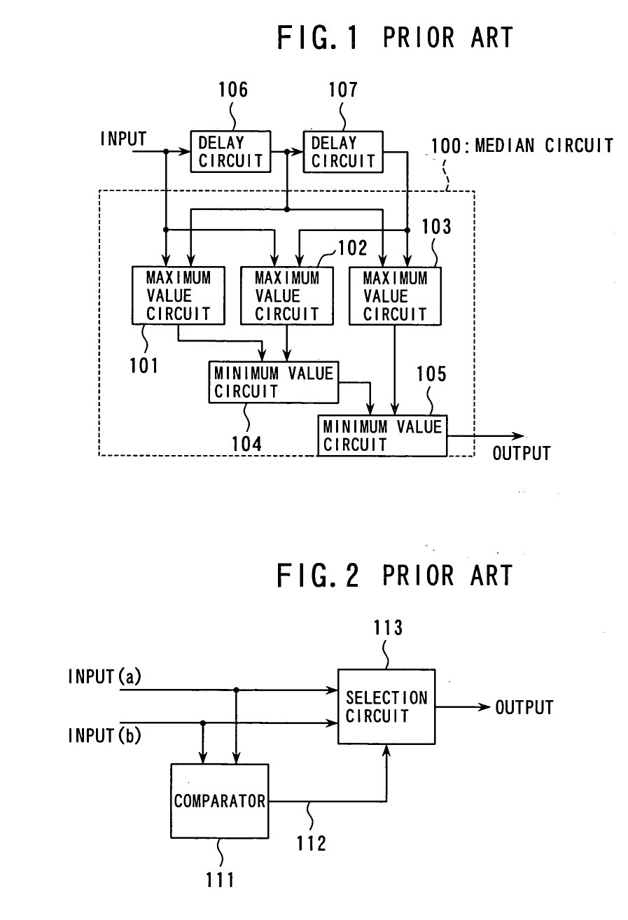

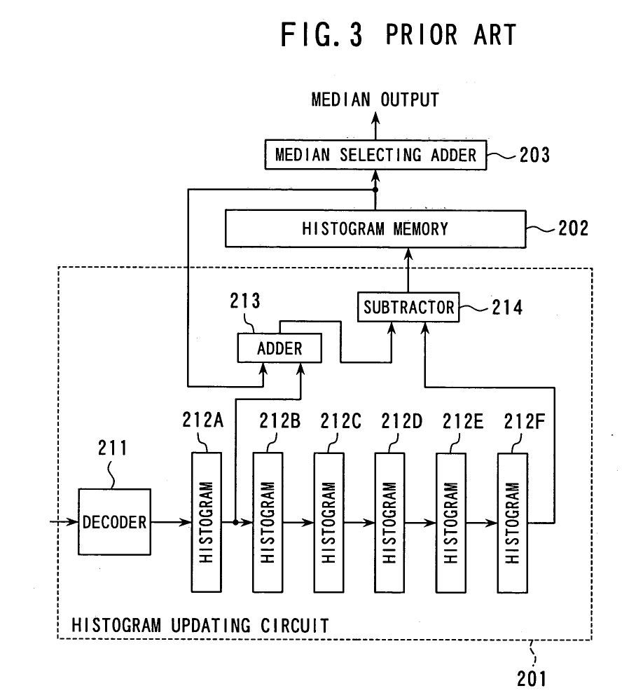

### DESCRIPTION OF THE PREFERRED EMBODIMENTS

An embodiment of the present invention will now be described. Here, for ease of explanation, it is supposed that: the size of window containing the pixel to be observed is 5×5; the value of a pixel is represented by an 8-bit uncoded integer (0 to 255); and the window containing the pixel to be observed is relocated pixel by pixel in the vertical direction to obtain medians corresponding to one frame. Further, minimum values are employed as the extreme value to be retained at the extreme value retaining means.

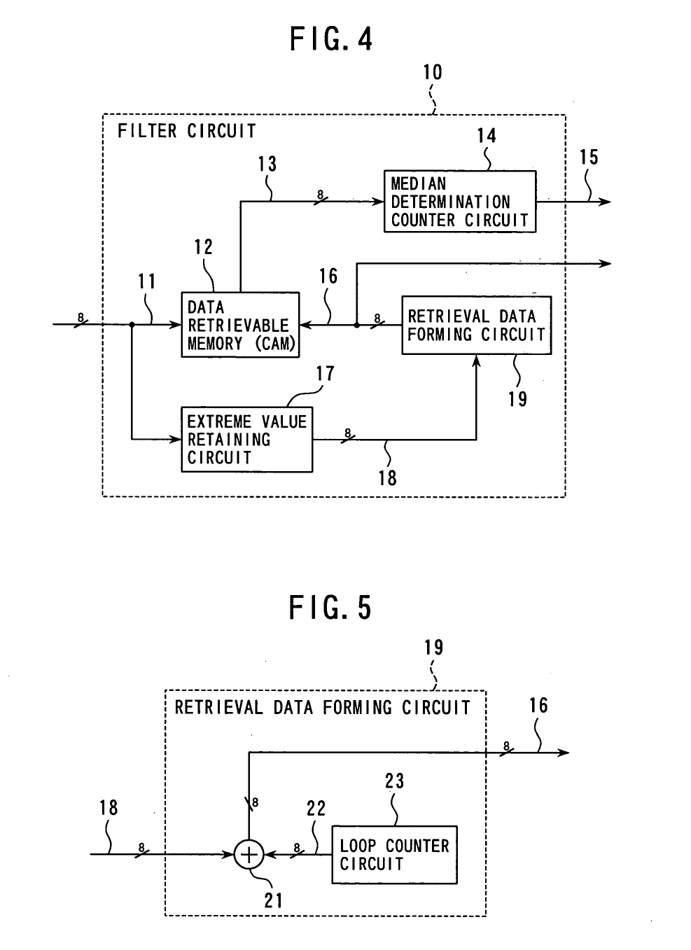

FIG. 4 is a block diagram showing a filter circuit according to the present embodiment. The principle of the invention will first be described by way of FIG. 4. Referring to FIG. 4, a data retrievable memory 12, a median determination counter circuit 14, and a retrieval data forming circuit 19 constitute a data retrieval determination means. A filter circuit 10 is then constituted by the data retrieval determination means and an extreme value retaining circuit 17.

The operation principle will now be briefly described. The values of each pixel within a window containing the pixel to be observed are first inputted to the filter circuit 10 as input data 11. The input data 11 are inputted to the data retrievable memory (CAM) 12 and to the extreme value retaining circuit 17. The extreme value retaining circuit 17 obtains an extreme value in the input data 11 and outputs it to the retrieval data forming circuit 19 as extreme value data 18. The retrieval data forming circuit 19 forms a retrieval data 16 by using the extreme value data 18 as initial value and outputs it to the data retrievable memory 12. The retrieval data 16 is also outputted to the outside as median data outputted from the filter circuit 10.

The data retrievable memory 12 effects retrieval as to whether or not the retrieval data 16 occurs in the input data 11, and outputs the number of units of input data 11 coinciding the retrieval data 16 to the median determination counter circuit 14 as coincidence count data 13. The median determination counter circuit 14 counts the coincidence count data 13 so as to output a carry as a median heuristic flag 15 when the count value has exceeded one half of the window size 5×5, i.e., when it has become 13 or more.

In this manner, it becomes possible to readily obtain a median of the inputted data. Here, since a contents-addressable memory (CAM) is capable of concurrently effecting retrieval for all stored data, the speed of the processing can be increased by using a contents-addressable memory (CAM) as the data retrievable memory 12.

A description will now be given with respect to a detailed circuit construction of each circuit of the filter circuit according to this embodiment. FIG. 5 is a block diagram typically showing the retrieval data forming circuit 19 where the result of an addition at an adder 21 obtained by adding the inputted extreme value data 18 and a count value 22 outputted from an internally located loop counter circuit 23 to each other is outputted as retrieval data 16.

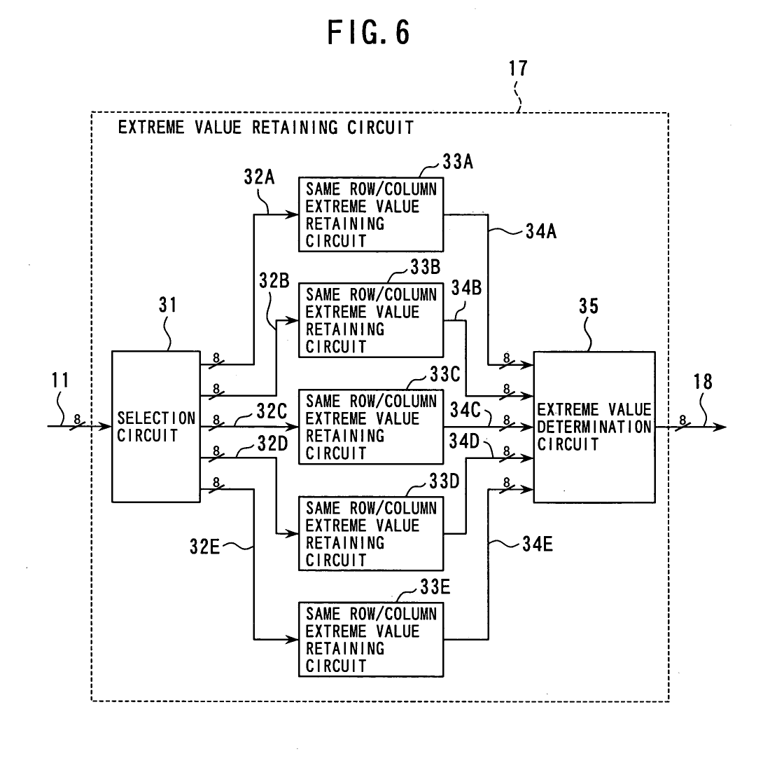

FIG. 6 is a block diagram typically showing the extreme value retaining circuit 17 where a selection circuit 31 distributes the input data 11 to same row/column input data 32A to 32E, and the same row/column input data 32A to 32E are inputted to same row/column extreme value retaining circuits 33A to 33E, respectively. The same row/column extreme value retaining circuits 33A to 33E output extreme values (minimum values in the case of the present embodiment) of the inputted data 32A to 32E to an extreme value determination circuit 35 as same row/column extreme value data 34A to 34E. The extreme value determination circuit 35 then outputs an extreme value (minimum value in the case of the embodiment) among the inputted same row/column extreme value data 34A to 34E as an extreme value data 18 for the input data 11.

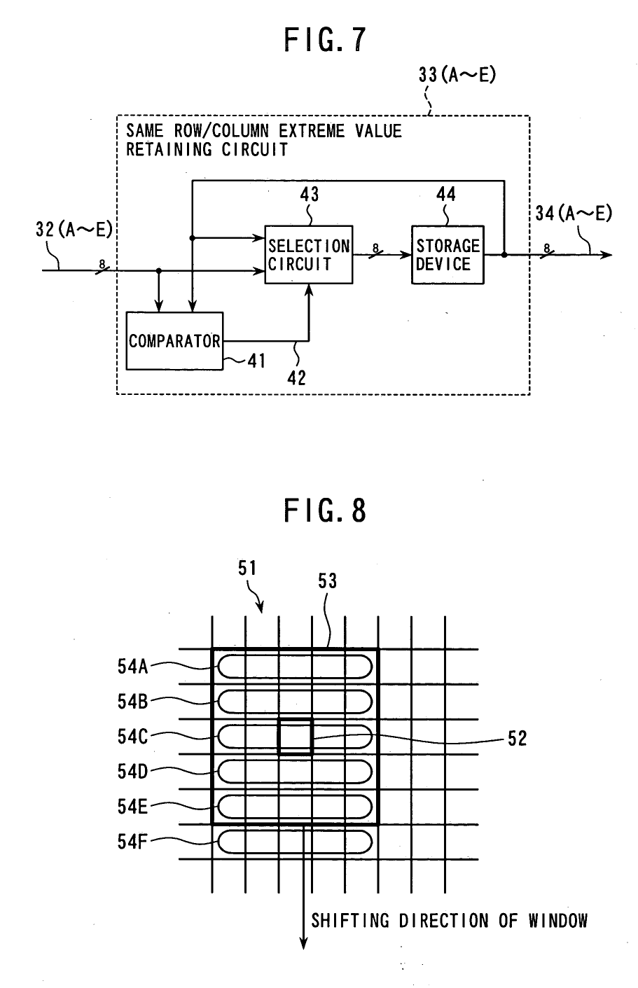

FIG. 7 is a block diagram typically showing the same row/column extreme value retaining circuit 33A to 33E where a comparator 41 compare the magnitude of the inputted same row/column input data 32A to 32E with that of the same row/column extreme value data 34A to 34E stored in a storage device 44 and outputs a comparison result 42 to a selection circuit 43. Based on the comparison result 42, the selection circuit 43 then selects and outputs to the storage device 44 one or the other of the same row/column input data 32A to 32E and the same row/column extreme value data 34A to 34E. The storage device 44 stores the inputted data and outputs it as same row/column extreme value data 34A to 34E.

The technique for obtaining medians will now be described by way of an example of 5×5 size window containing the pixel to be observed with reference to the construction of each circuit typically shown in FIGS. 4 to 7. FIG. 8 shows an example of the window where a pixel 52 to be observed and a window 53 (5×5 in the case of the present embodiment) as the window containing the pixel 52 to be observed are set with respect to a pixel matrix 51. Same row pixel groups 54A to 54F are also set therein. The moving direction of the window at this time is such that it is relocated pixel by pixel in the vertical direction as shown in FIG. 8. Further, the value of a pixel is 8-bit uncoded integer (0 to 255) and a minimum value is used as the extreme value to be retained at the extreme value retaining circuit 17.

First, the pixel values contained in the window 53 are inputted as input data 11 to the data retrievable memory (CAM) 12 and to the extreme value retaining circuit 17. At this time, storing address in the data retrievable memory (CAM) 12 is previously determined for each of the same row pixel groups 54A to 54E.

Further, the values of the pixels contained in the same row pixel group 54A are inputted as same row/column input data 32A to the same row/column extreme value retaining circuit 33A of the extreme value retaining circuit 17, and the values of the pixels contained in the same row pixel group 54B are inputted as same row/column input data 32B to the same row/column extreme value retaining circuit 33B. Likewise, the values of the pixels contained in the same row pixel groups 54C to 54E are respectively inputted as same row/column input data 32C to 32E to the same row/column extreme value retaining circuits 33C to 33E.

Since extreme value data 18 has already been outputted to the retrieval data forming circuit 19 from the extreme value retaining circuit 17 at the step of the inputting of all pixel values contained in the window 53, the retrieval data forming circuit 19 forms retrieval data 16 by using the extreme value data 18 as initial value and outputs it to the data retrievable memory (CAM) 12.

The data retrievable memory (CAM) 12 into which the retrieval data 16 has been inputted effects retrieval as to how many of the stored input data occur as having the same value as the retrieval data 16. The number of coinciding units is then outputted to the median determination counter circuit 14 as coincidence count data 13. The median determination counter circuit 14 counts the coincidence count data 13. When the count value has exceeded one half of the number of the pixels contained in the window 53 (5×5/2=13 or more in the present embodiment), the median heuristic flag 15 is driven to High level from Low level.

When an output for driving the median heuristic flag 15 to High level is provided from the median determination counter circuit 14, an external circuit (not shown) determines the retrieval data being outputted from the retrieval data forming circuit 19 at that point in time as a median and the median is outputted from the filter circuit 10.

Next, when the pixel 52 to be observed and the window 53 are to be relocated by one row in the vertical direction to obtain a median for replacing the value of the pixel which has newly become a pixel 52 to be observed, the values of the pixels of the same row pixel group 54F to be newly added to the window 53 are inputted as input data 11 to the data retrievable memory 12 and to the extreme value retaining circuit 17. At this time, updating is effected by superscribing the values of the pixels of the same row pixel group 54F on the values of the pixels of the same row pixel group 54A stored in the data retrievable memory 12 which are to be excluded from the window 53.

Further, the input data 11 is distributed to the same row/column input data 32A by the selection circuit 31 of the extreme value retaining circuit 17 so as to update the same row/column extreme value data 34A of the same row pixel group 54A having been retained by the same row/column extreme value retaining circuit 33A by using an extreme value of the same row pixel group 54F.

Subsequently, the same row/column extreme value data 34A to 34E are inputted to the extreme value determination circuit 35 to update extreme value data 18, and the retrieval data 16 is then updated again through the retrieval data forming circuit 19 to start retrieval of data stored in the data retrievable memory 12.

The medians corresponding to one frame can be obtained by repeating the operation up to this point to the final row of the pixel matrix 51 while relocating the processing window 52 row by row.

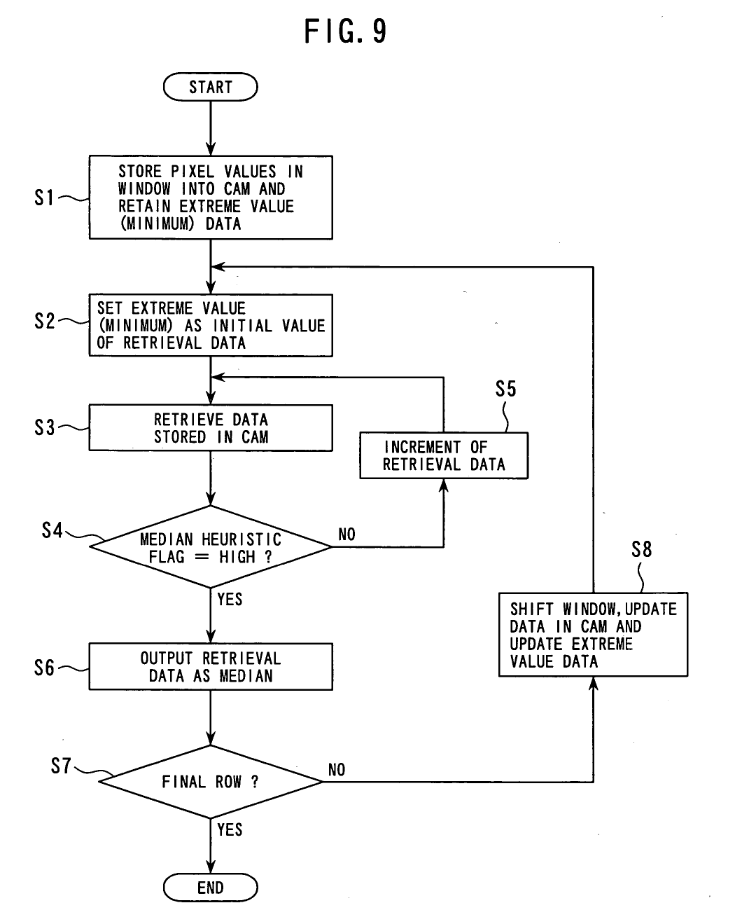

The outlines of the above described filtering processing of the filter circuit according to the present embodiment are shown in the flowchart of FIG. 9. First, at step S1, the values of the pixels within the processing window are stored to the data retrievable memory (CAM) 12 and an extreme value data (minimum value in the case of this embodiment) is retained at the extreme value retaining circuit 17. At step A2, the extreme value data (minimum value in the case of this embodiment) is set as an initial value of retrieval data at the retrieval data forming circuit 19. At step S3, retrieval is effected of the input data stored in the data retrievable memory (CAM) 12, and the number of units of the input data coinciding the retrieval data is cumulatively counted at the median determination counter circuit 14.

A median heuristic flag by the median determination counter circuit 14 is checked at step S4. If the median heuristic flag is Low, the system proceeds to step S5 where an increment of the retrieval data from the retrieval data forming circuit 19 is effected and the processing from step S3 is then executed again. If the median heuristic flag is High, the system proceeds to step S6 where the retrieval data is outputted as a median data. Next, at step S7, if the processing of the final row of the pixel matrix has been completed, the median filtering processing is terminated. If it is not yet of the final row, the system proceeds to step S8 where the processing window is relocated and the processing from step S2 is executed again with updating data stored in the data retrievable memory (CAM) 12 and the extreme value data in the extreme value retaining circuit 17.

With the above construction and technique, the medians corresponding to one frame can be obtained by a filter circuit consisting of small-scale digital circuits.

It should be noted that, while a window size of 5×5 and pixel values of 8-bit uncoded integer have been used in the present embodiment, these are not limited to such and both the window size and the pixel values can naturally be set at will. Also, naturally, the moving direction of the window is not limited. Further, while a minimum value has been used as the extreme value to be retained at the extreme value retaining circuit, a maximum value can also be used. Furthermore, while a contents-addressable memory (CAM) has been used as the data retrievable memory, it is not limited to such and a random-access memory (RAM) or the like can naturally also be used. If a random-access memory (RAM) is used, however, a construction by small-scale digital circuits as in the case of using a contents-addressable memory (CAM) becomes difficult to be achieved. Moreover, while one for obtaining medians has been shown in the above embodiment, the values of pixel at a predetermined ordinal position in an ascending or descending order can be obtained in a similar manner.

As has been described by way of the above embodiment, according to the first aspect of the invention, since it is unnecessary to use a comparator circuit to reorder pixel values into an ascending or descending order or to form histogram data thereof in order to obtain the value of the pixel at a predetermined ordinal position in the ascending or descending order within a window, the processing becomes simpler and a filter circuit consisting of small-scale digital circuits can be constructed. According to the second aspect, a data retrieval determination means for cumulatively adding frequencies of occurrence of pixel values within the window can be constructed by digital circuits. According to the third aspect, it is always possible to have stored only the values of the pixels located within the window in the data retrievable memory. According to the fourth aspect, it is possible to readily construct the data retrievable memory by digital circuit.

According to the fifth aspect, a high-speed filtering processing becomes possible, since use of an extreme value of the values of the pixels occurring in the processing window as an initial value of retrieval data makes it possible to lower the possibility of making a value not occurring in the processing window as retrieval data. According to the sixth aspect, it is readily possible to check the fact that the value of the pixel at the predetermined ordinal position in ascending or descending order has been found. According to the seventh aspect, it is always possible at the extreme value retaining means to retain an extreme value of the values of the pixels occurring within the window. According to the eighth aspect, it becomes possible to output the value of pixel at the predetermined ordinal position in ascending or descending order without reordering the values of the pixels into an ascending or descending order by using a comparator and without forming histogram data.

What is claimed is:

1. A filter circuit receiving the values of a pixel to be observed and of each pixel within a window containing the pixel to be observed as input data expressed by integers, for replacing the value of said pixel to be observed with the value of pixel at a predetermined ordinal position in an ascending or descending order within said window, said filter circuit comprising:
an extreme value retaining means for obtaining and retaining an extreme value of the values of the pixels within said window; and
a data retrieval determination means receiving extreme value data from the extreme value retaining means and the input data, for obtaining the value at a predetermined ordinal position in the ascending or descending order by cumulatively adding frequencies of occurrence of the values of the pixels within said window.

2. The filter circuit according to claim 1, wherein said data retrieval determination means comprises:
a data retrievable memory capable of storing the values of each pixel located within said window and capable of outputting information of the number of addresses having coincident values by effecting data retrieval;
a retrieval data forming means for inputting retrieval data to the data retrievable memory; and
a counter means for cumulatively adding the information of the number of addresses having values coinciding said retrieval data.

3. The filter circuit according to claim 2, wherein said data retrievable memory arranges the values of each pixel within said window into groups each of pixels of a same row or column and stores data thereof with assigning an address to each group so that, in obtaining the value of pixel at the predetermined ordinal position in the ascending or descending order corresponding to one frame by relocating said pixel to be observed and said window containing said pixel to be observed in a predetermined direction, only the data of the group of the pixels of the row or column excluded from said window are updated using data newly added to said window.

4. The filter circuit according to claim 2 or 3, wherein said data retrievable memory comprises a contents-addressable memory.

5. The filter circuit according to claim 2 or 3, wherein said retrieval data forming means forms said retrieval data by using said extreme value retained at said extreme value retaining means as an initial value.

6. The filter circuit according to claim 4, wherein said retrieval data forming means forms said retrieval data by using said extreme value retained at said extreme value retaining means as an initial value.

7. The filter circuit according to claim 2 or 3, wherein said counter means outputs a carry at a count of or more than said predetermined ordinal position in the ascending or descending order and uses the carry as a heuristic signal of the value of pixel at said predetermined ordinal position in the ascending or descending order.

8. The filter circuit according to claim 4, wherein said counter means outputs a carry at a count of or more than said predetermined ordinal position in the ascending or descending order and uses the carry as a heuristic signal of the value of pixel at said predetermined ordinal position in the ascending or descending order.

9. The filter circuit according to claim 5, wherein said counter means outputs a carry at a count of or more than said predetermined ordinal position in the ascending or descending order and uses the carry as a heuristic signal of the value of pixel at said predetermined ordinal position in the ascending or descending order.

10. The filter circuit according to claim 6, wherein said counter means outputs a carry at a count of or more than said predetermined ordinal position in the ascending or descending order and uses the carry as a heuristic signal of the value of pixel at said predetermined ordinal position in the ascending or descending order.

11. The filter circuit according to claim 1, wherein said extreme value retaining means arranges the values of each pixel within said window into groups each of pixels of a same row or column and obtains and retains an extreme value separately for each group so that, in obtaining the value of pixel at the predetermined ordinal position in the ascending or descending order corresponding to one frame by relocating said pixel to be observed and said window containing the pixel to be observed in a predetermined direction, only the extreme value of the group of the pixels of the same row or column excluded from said window are updated using an extreme value of data of the group newly added to said window.

12. The filter circuit according to claim 7, wherein said data retrieval determination means outputs said retrieval data at the time of the outputting of said heuristic signal from said counter means as the value of pixel of said predetermined ordinal position in the ascending or descending order.

13. The filter circuit according to claim 8, wherein said data retrieval determination means outputs said retrieval data at the time of the outputting of said heuristic signal from said counter means as the value of pixel of said predetermined ordinal position in the ascending or descending order.

14. The filter circuit according to claim 9, wherein said data retrieval determination means outputs said retrieval data at the time of the outputting of said heuristic signal from said counter means as the value of pixel of said predetermined ordinal position in the ascending or descending order.

15. The filter circuit according to claim 10, wherein said data retrieval determination means outputs said retrieval data at the time of the outputting of said heuristic signal from said counter means as the value of pixel of said predetermined ordinal position in the ascending or descending order.
